(19) United States
(12) Patent Application Publication
(10) Pub. No.: US 2004/0240564 A1
(43) Pub. Date: Dec. 2, 2004

(54) Method and device for single conductor local transmission of pcm signals without transformers

(76) Inventors: Johann Amstutz, Niederrohrdorf (CH); Karl Formanek, Wien (AT)

Correspondence Address: Siemens Corporation, Intellectual Property Department, 170 Wood Avenue South, Iselin, NJ, 08830, US

(21) Appl. No.: 10/488,322

(22) PCT Filed: Aug. 27, 2002
(86) PCT No.: PCT/DE02/03134

(30) Foreign Application Priority Data
Aug. 31, 2001 (DE) 101 42 612.7

(51) Int. Cl. H04B 3/00

(52) U.S. Cl. 375/257

(57) ABSTRACT

The invention relates to a data communication system, an electronic module with a receiver device, and an electronic module with a transmitter device having two outputs which are used to transmit a differential or symmetrical signal from the transmitter device. The invention is characterized in that the electronic module is also provided with a converter which is used to convert the differential or symmetrical signal into an asymmetrical signal.

### CROSS REFERENCE TO RELATED APPLICATIONS

This application is the US National Stage of International Application No. PCT/DE02/03134, filed Aug. 27, 2002 and claims the benefit thereof. The International Application claims the benefits of German application No. 10142612.7 filed Aug. 31, 2001, both of the applications are incorporated by reference herein in their entirety.

### FIELD OF INVENTION

The invention relates to an electronic module with a receiver device according to the preamble of claim 1, to a data communication system with an electronic module of said type, and to an electronic module with a transmitter device according to the preamble of claim 11.

### BACKGROUND OF INVENTION

Conventional data communication systems generally have a plurality of transmitter/receiver devices interconnected via, for example, two-wire twisted pairs over which data can be transmitted between said devices. A first transmitter/receiver device can be, for instance, an electronic module of an EWSD (EWSD: German abbreviation standing for ‘Digital Electronic Switching System’) terminating switching center which additionally has a plurality of other electronic modules, and a second transmitter/receiver device can be, for example, an electronic module of a terminating subscriber line.

The modules each have, for example, one or more framers each having a receiving unit with two receive inputs and each having a transmitting unit with two send outputs. The two send outputs of the EWSD terminating switching center module are connected—with interfacing provided by a transformer component—with the aid, for example, of a two-wire line pair to two corresponding receive inputs of the subscriber line module located remotely from the EWSD switching center. Vice versa in an analogous manner, two send outputs of the subscriber line module are connected—with interfacing similarly provided by a transformer component—with the aid of another two-wire line pair to two corresponding receive inputs of the EWSD terminating switching center module.

The transformer component serves, for example, to provide dc isolation between the line and the relevant module and to perform (voltage) matching, etc.

Data is transmitted over the respective line pairs in each case with the aid of differential or, as the case may be, symmetrical signals.

A PCM (PCM: Pulse Code Modulation) data transmission protocol is frequently used for this. PCM data transmission methods allow data to be transmitted on a single line pair over several, for example 32, different channels using time-division multiplexing. A single channel within a specific PCM data transmission frame of, for example, 125 μs duration, is here in each case assigned a specific timeslot lasting, for example, 3.9 μs. One of the channels is used, for example, for transmitting synchronizing data and the like, another channel is used for transmitting call processing data, and the remaining 30 channels are used for transmitting useful data.

### SUMMARY OF INVENTION

The object of the invention is to provide a new type of electronic module with a receiver device, a new type of data communication system, and a new type of electronic module with a transmitter device.

The invention achieves these and other objects by means of the subject matter recited in claims 1, 11, and 16. Advantageous developments of the invention are disclosed in the subclaims.

According to a basic idea of the invention, an electronic module with a transmitter device is provided which has at least two outputs via which a differential or, as the case may be, symmetrical signal is sent from the transmitter device, with the electronic module also having a converter for converting the differential or, as the case may be, symmetrical signal into an asymmetrical signal.

The electronic module alternatively or additionally has a receiver device having at least two inputs via which a differential or, as the case may be, symmetrical signal is routed to the receiver device, with the electronic module also having an adapter enabling the receiver device designed for receiving symmetrical signals to receive asymmetrical signals, or, as the case may be, a converter for converting a received asymmetrical signal into a differential or, as the case may be, symmetrical signal routed to the receiver device.

In a preferred embodiment, the electronic module has an interface device, in particular a connecting device, which is connected to the relevant converter or, as the case may be, adapter, and which is embodied such that a single-wire line can be connected to it via which the asymmetrical signal can be fed out or, as the case may be, received.

Said line requires less space than the two-wire line employed in the prior art and is cheaper to fabricate. Moreover, the number of connector pins required for connecting single-wire lines is only half that required for connecting two-wire line pairs.

With preferred embodiments of the invention it is furthermore possible to dispense with the cited transformer connected between the transmitter device and the interface device, in particular the connecting device. This further reduces the dimensions and fabrication costs of the electronic module as well as the power consumption.

The electronic module particularly advantageously has a device whose impedance is selected such that the impedance of said module is matched to that of the (single-wire) line. This allows the waveform of the signals that are fed out to be influenced and hence the proper functioning of the module or, as the case may be, of another module connected to it to be ensured.

In a preferred embodiment of the invention the transmitter and/or receiver device forms part of a conventional, standard PCM framer device.

### BRIEF DESCRIPTION OF THE DRAWINGS

The invention is described in more detail below with the aid of several exemplary embodiments and the attached drawing, in which:

FIG. 1 is a schematic of a data communication system according to the prior art;

FIG. 2 is a detailed schematic of an electronic module located in the EWSD terminating switching center shown in FIG. 1 and of an electronic module located in the terminating subscriber line shown in FIG. 1;

FIG. 3 is a schematic of a data communication system according to a first exemplary embodiment of the invention; and

FIG. 4 is a schematic of a data communication system according to a second exemplary embodiment of the invention;

FIG. 5 is a detailed schematic of the transmitter conversion switch unit shown in FIG. 4; and

FIG. 6 is a detailed schematic of the receiver conversion switch unit shown in FIG. 4.

### DETAILED DESCRIPTION OF INVENTION

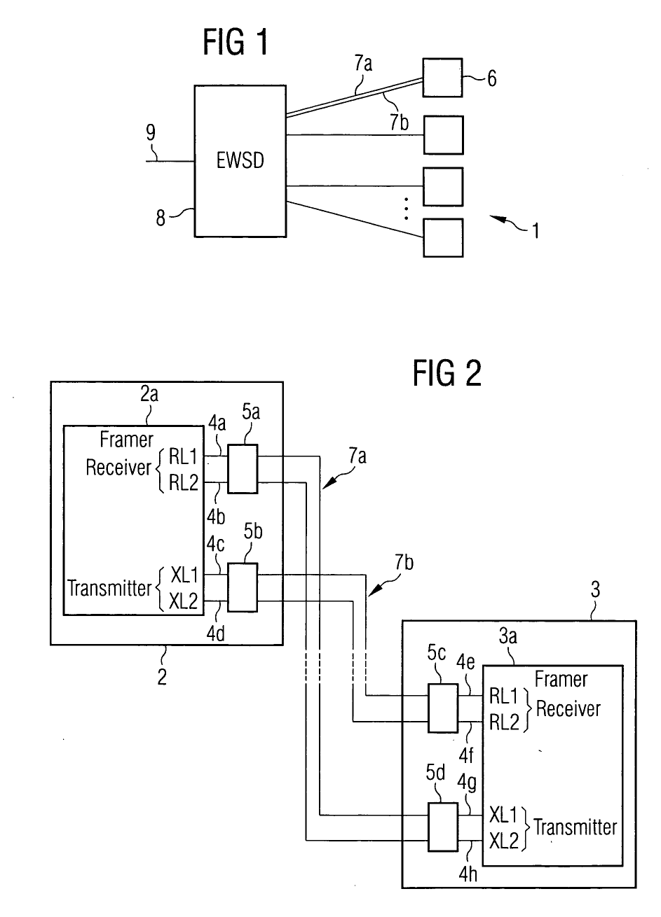

FIG. 1 shows an example of a data communication system 1 according to the prior art.

In the case of data communication system 1 a terminating switching center 8 (in this case a digital electronic switching system, or EWSD) is connected to a telephone network (in this case to public telephone network 9). Terminating switching center 8 has a plurality of electronic modules 2. Said modules can be connected via, for example, corresponding twisted pairs 7a, 7b to other electronic modules 3 located, for example, on a terminating subscriber line 6 situated remotely from terminating switching center 8.

FIG. 2 is a detailed schematic of a first electronic module 2 located in EWSD terminating switching center 8 and of a second electronic module 3 located in terminating subscriber line 6.

Modules 2, 3 each have a framer 2a, 3a each having a receiving unit with two differential receive inputs RL1, RL2, and each having a transmitting unit with two differential send outputs XL1, XL2.

Both the receive inputs RL1, RL2 of EWSD terminating switching center framer 2a are connected via two lines 4a, 4b to corresponding inputs of a transformer component 5a. Said component has two outputs to which, for example by means of a corresponding plug-in connection, a two-wire twisted pair 7a is connected.

Both the send outputs XL1, XL2 of EWSD terminating switching center framer 2a are analogously connected via two lines 4c, 4d to corresponding inputs of another transformer component 5b. Said component likewise has two outputs which can be connected via a plug-in connection to another two-wire twisted pair 7b.

Twisted pairs 7a, 7b run from terminating switching center module 2 to terminating subscriber line module 3. The first and second wire of first twisted pair 7a are connected via a plug-in connection to two corresponding inputs of a terminating subscriber line transformer component 5c. The first and second wire of second twisted pair 7b are analogously connected via another plug-in connection to two corresponding inputs of another terminating subscriber line transformer component 5d.

As further shown in FIG. 2, two outputs of first terminating subscriber line transformer component 5c are connected via corresponding lines 4e, 4f to two receive inputs RL1, RL2 of terminating subscriber line framer 3a. Two outputs of second terminating subscriber line transformer component 5d are analogously connected via two other lines 4g, 4h to two send outputs XL1, XL2 of terminating subscriber line framer 3a.

Transformer components 5a, 5b, 5c, 5d serve, for example, to provide DC isolation (galvanic isolation) between twisted pairs 7a, 7b and the respective framer 2a, 3a, and to perform (voltage) matching, etc.

Data is transmitted over twisted pairs 7a, 7b in each case with the aid of differential or, as the case may be, symmetrical PCM (PCM: Pulse Code Modulation) signals.

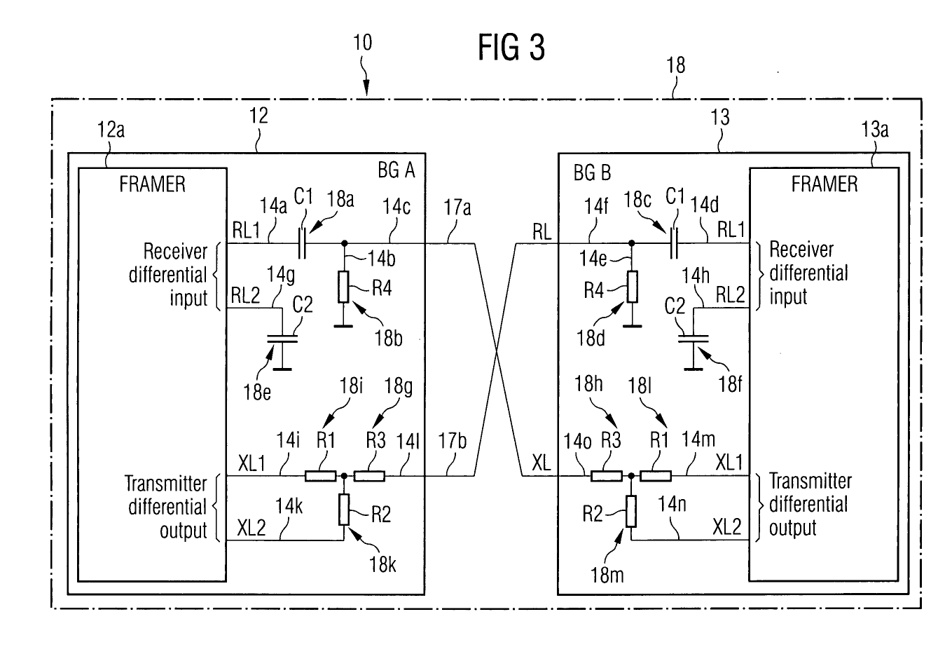

FIG. 3 is a schematic of a data communication system 10 according to a first exemplary embodiment of the invention.

Data communication system 10 has a plurality of electronic modules 12, 13. The electronic modules are located in a rack or, as the case may be, in a subrack of a terminating switching center 18 (in this case a digital electronic switching system, or EWSD) connected to a (public or private) telephone network.

Modules 12, 13 (or, as the case may be, the corresponding printed circuit boards) are inserted into corresponding slots in the rack and each have a framer 12a, 13a (of standard embodiment) having in each case a receiving unit with two (differential) receive inputs RL1, RL2 and in each case a transmitting unit with two (differential) send outputs XL1, XL2. Framers 12a, 13a correspond to framers 2a, 3a shown in FIG. 2 and serve as a PCM interface component for transmitting and receiving data over conventional PCM 30 lines, with the (for example analog) signals used within the respective module 12, 13 being converted into corresponding differential (digital) signals corresponding to the PCM (PCM: Pulse Code Modulation) data transmission protocol.

Framers 12a, 13a are embodied, configured, and designed, and accordingly provided by the manufacturer of said framers in such a way that—analogously to framers 2a, 3a shown in FIG. 2—they can serve, with interfacing provided by corresponding transformer components 5a, 5b, 5c, 5d, to transmit differential or, as the case may be, symmetrical signals in each case over two-wire line pairs 7a, 7b.

As will be explained in more detail below, by means of specially designed external wiring of framers 12a, 13a the present exemplary embodiment enables asymmetrical signals to be sent from the respective module 12, 13—without the interfacing shown in FIG. 2 provided by (standardized) transformer components 5a, 5b, 5c, 5d—instead of the above-mentioned symmetrical signals transmitted over two-wire line pairs 7a, 7b. This is done over the single-wire lines 17a, 17b shown in FIG. 3. Said lines are formed—at least partially—by means of the backplane wiring of terminating switching center 18, for example by means of corresponding striplines or microstriplines arranged on the backplane.

As is further shown in FIG. 3, the first, non-inverted differential receive input RL1 of first framer 12a is connected via a line 14a to a first capacitor 18a whose output is connected via a line 14b to a resistor 18b which is connected to the ground, and via another line 14c to a connecting device (not shown) to which the above-mentioned first single-wire line 17a can be connected.

The first, non-inverted differential receive input RL1 of second framer 13a is analogously connected via a line 14d to a capacitor 18c whose output is connected via a line 14e to a resistor 18d which is connected to the ground, and analogously connected via another line 14f to a connecting device (not shown) to which the above-mentioned second single-wire line 17b can be connected.

Modules 12, 13 are each operated in, for example, “short haul” mode, which is to say in a mode provided for short lengths of connecting cable.

As is further shown in FIG. 3, in the case of the first framer 12a the second (inverted) receive input RL2 is connected via a line 14g to another capacitor 18e whose output is grounded. The (unused) receive input is hence applied (on an alternating-current basis) to reference potential (ground). In the case of the second framer 13a the second (inverted) receive input RL2 is analogously connected via a line 14h to a capacitor 18f which is likewise connected to the ground.

Capacitors 18a, 18c, 18e, 18f each have a capacitance of, for example, 50 nF to 200 nF, in particular a capacitance Cl or, as the case may be, C2 of 100 nF, and resistors 18b, 18d have a resistance of between 500Ω and 1.5 kΩ, in particular a resistance R4 of 1 kΩ. It is alternatively also possible to dispense with resistors 18b, 18d (which is to say that R4 will then be infinitely large). Capacitors 18a, 18c, 18e, 18f serve, for instance, to filter out low-frequency signal components from the respective receive signals.

The characteristic wave impedance Z of lines 17a, 17b, which is to say of the backplane wiring, depends on the respective design of the terminating switching center backplane and can be, for instance, 50 . . . 60Ω.

Lines 17a, 17b being terminated on the receiver side on a high-impedance basis (resistors 18b, 18d), the resistances prevailing on the transmitter side (which is to say the resistances at the send outputs or, as the case may be, line drivers XL1, XL2) are matched to the impedance of the back-plane wiring. As is explained below in even more detail, a send impedance 18g, 18h is used in each case for this. Lines 17a, 17b being relatively short, the signals are attenuated relatively weakly.

As is shown in FIG. 3, the first, non-inverted differential send output XL1 of the first framer 12a is connected via a line 14i to a resistor 18i which is connected to the above-mentioned send impedance 18g and, via a resistor 18k and a line 14k, to the second, inverted differential send output XL2. The send impedance 18g is connected via another line 14l to a connecting device (not shown) to which the above-mentioned second single-wire line 17b can be connected.

The first, non-inverted differential send output XL1 of the second framer 13a is analogously connected via a line 14m to a resistor 18l which is connected to the above-mentioned send impedance 18h and, via a resistor 18m and a line 14n, analogously connected to the second, inverted differential send output XL2 of the second framer 13a. The send impedance 18h is connected via another line 14o to a connecting device (not shown) to which the above-mentioned first single-wire line 17a can be connected.

Resistors 18k, 18m each have a resistance of between 20Ω and 100 kΩ, in particular a resistance R2 of 39Ω. Resistors 18i, 18l can be relatively small and, in the case of alternative exemplary embodiments, totally dispensed with (which is to say that R1 will then be 0Ω).

As explained above, impedance R3 of the send impedances is matched to impedance Z of the backplane wiring or, as the case may be, of lines 17a, 17b, and is selected, for example, according to the following formula:

R3=Z−Ri (at R1=0Ω)

Ri is the internal resistance of the framer driver stage or, as the case may be, of send outputs XL1, XL2. The internal resistance can be, for instance, 1.5Ω. Send impedances 18g, 18h can be formed, for example, by means of appropriately interconnected resistive and capacitive and/or inductive elements.

Several other modules, for example 63 further modules, can be connected to module 12—alongside module 13—in a manner analogous to that described above via other line pairs corresponding to lines 17a, 17b.

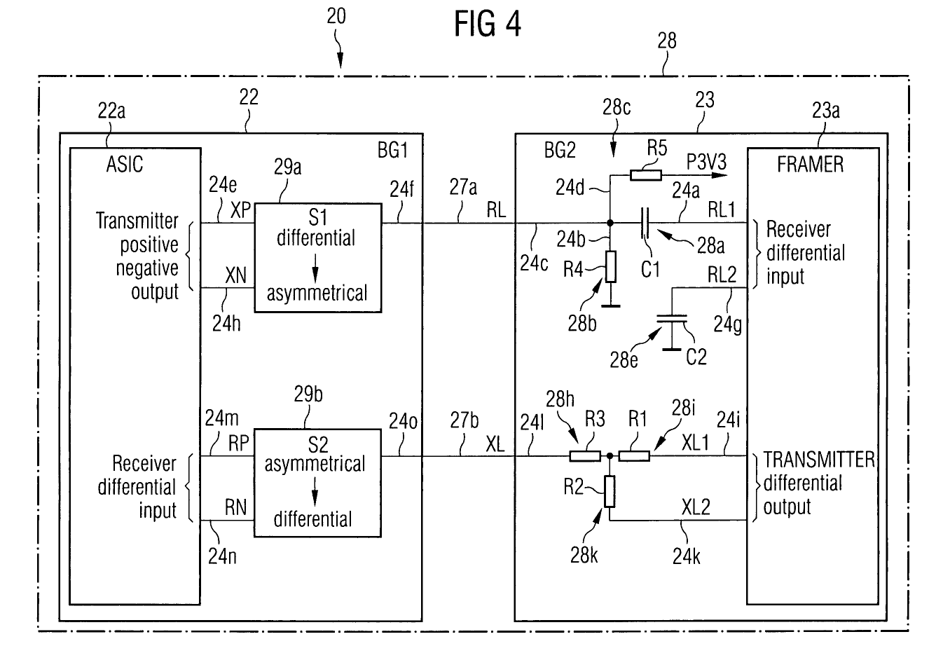

FIG. 4 is a schematic of a data communication system 20 according to a second exemplary embodiment of the invention.

Data communication system 20 has a plurality of electronic modules 22, 23. The electronic modules are located in a rack or, as the case may be, in a subrack of a terminating switching center 28 (in this case a digital electronic switching system, or EWSD) connected to a (public or private) telephone network.

Modules 22, 23 (or, as the case may be, the corresponding printed circuit boards) are inserted into corresponding slots in the rack.

The second module 23 has a framer 23a (of standard embodiment) having in each case a receiving unit with two (differential) receive inputs RL1, RL2 and in each case a transmitting unit with two (differential) send outputs XL1, XL2. Framer 23a corresponds to framers 2a, 2b shown in FIG. 2 and to framers 12a, 13a shown in FIG. 3, and serves, among other things, to effect digital/analog conversion of the input/output signals and to convert the signals used within module 13 into corresponding differential signals corresponding to the PCM (PCM: Pulse Code Modulation) data transmission protocol, in particular as a PCM interface component for transmitting data on conventional PCM 30 lines.

Framer 23a is embodied, configured, and designed, and accordingly provided by the manufacturer of said framer in such a way that—analogously to framers 2a, 3a shown in FIG. 2—it can serve, with interfacing provided by corresponding transformer components 5a, 5b, 5c, 5d, to transmit differential or, as the case may be, symmetrical signals in each case over two-wire line pairs 7a, 7b.

In contrast to this, by means of specially designed external wiring of framer 23a the present exemplary embodiment enables asymmetrical signals to be sent from module 23—without the interfacing shown in FIG. 2 provided by (standardized) transformer components 5a, 5b, 5c, 5d—instead of the above-mentioned symmetrical signals transmitted over two-wire line pairs 7a, 7b. Transmission takes place in each case over the single-wire lines 27a, 27b shown in FIG. 4, which are formed—at least partially—by means of the backplane wiring of terminating switching center 28, for example by means of corresponding striplines or microstriplines arranged on the backplane.

The first, non-inverted differential receive input RL1 of framer 23a is connected to a first capacitor 28a via a line 24a. The output of capacitor 28a is connected via a line 24b to a resistor 28b connected to the ground, via a line 24d to a resistor 28c connected to a +3.3 V supply voltage, and via a line 24c to a connecting device (not shown) to which the above-mentioned first single-wire line 27a can be connected.

Module 23 is operated in, for example, “short haul” mode, which is to say in a mode provided for short lengths of connecting cable.

As is further shown in FIG. 4, in the case of the first framer 23a the second (inverted) receive input RL2 is connected via a line 24g to another capacitor 28e whose output is grounded. The (unused) receive input is hence applied (on an alternating-current basis) to reference potential (ground).

Capacitors 28a, 28e each have a capacitance of, for example, 50 nF to 200 nF, in particular a capacitance C1 or, as the case may be, C2 of 100 nF, and resistors 28b, 28c have a resistance of between 500Ω and 6 kΩ in particular a resistance R4 or, as the case may be, R5 of 3.32 kΩ. It is alternatively also possible to dispense with resistor 28b and/or 28d or, as the case may be, 28c (which is to say, for example, that R4 will then be infinitely large). Capacitors 28a, 28e serve, for instance, to filter out low-frequency signal components from the respective receive signals.

The characteristic wave impedance Z of lines 27a, 27b, which is to say of the backplane wiring, depends on the respective design of the terminating switching center backplane and can be, for instance, 50 . . . 60Ω.

The resistance on the send outputs or, as the case may be, line drivers XL1, XL2 of framer 23a is matched with the aid of a send impedance 28h to the impedance of the backplane wiring.

As is shown in FIG. 4, the first, non-inverted differential send output XL1 of framer 23a is connected via a line 24i to a resistor 28i which is connected to the above-mentioned send impedance 28h and, via a resistor 28k and a line 24k, to the second, inverted differential send output XL2. The send impedance 28h is connected via another line 24l to a connecting device (not shown) to which the above-mentioned second single-wire line 27b can be connected.

Resistor 28k has a resistance between 20Ω and 100Ω, in particular a resistance R2 of 37Ω. Resistor 28i can be relatively small (having a resistance R1 of, for example, 2.2Ω) and, in the case of alternative exemplary embodiments, can be totally dispensed with (which is to say that R1 will then be 0Ω).

As explained above, impedance R3 of the send impedance 28h is matched to impedance Z of the backplane wiring and is selected, for example, according to the following formula:

R3=Z−Ri−R1 (or, as the case may be, R3=Z−Ri (at R1=0Ω))

Ri is the internal resistance of the framer driver stage or, as the case may be, of send outputs XL1, XL2. The internal resistance can be, for instance, 1.5Ω. Send impedance 28h can be formed, for example, by means of appropriately interconnected resistive and capacitive and/or inductive elements. Said impedance ensures proper functioning of the driver stages of framer 23a, among other things for the corresponding waveform of the output signals.

Far-end module 22 has an ASIC (ASIC: Application-Specific Integrated Circuit) 22a having in each case a receiving unit with two (differential) receive inputs RP, RN, and in each case a transmitting unit with two (differential) send outputs XP, XN.

Far-end module 22 also has a first and a second conversion switch unit 29a, 29b. A first output of the second conversion switch unit 29b is connected via a line 24m to the first, positive receive input RP of ASICS 22a, and a second output of the second conversion switch unit 29b is connected via a line 24n to the second, negative ASIC receive input RN.

A first input of the first conversion switch unit 29a is analogously connected via a line 24e to the first, positive send output XP of ASICS 22a, and a second input of the first conversion switch unit 29a is analogously connected via a line 24h to the second, negative ASIC send output XN. An output of the first conversion switch unit 29a is connected via a line 24f to a connecting device (not shown) to which the above-mentioned first single-wire line 27b can be connected.

An input of the second conversion switch unit 29b is analogously connected via a line 24o to a connecting device (not shown) to which the above-mentioned second single-wire line 27b can be connected.

In the second conversion switch unit 29b, the asymmetrical signal, which is to say the signal referred to ground, transmitted from module 23 over the second, single-wire line 27b is converted into a differential (symmetrical) signal, routed via lines 24m, 24n to the differential receiving unit of ASICS 22a, and further processed there.

Vice versa in an analogous manner, in the first conversion switch unit 29a the symmetrical signal sent by ASIC 22a over lines 24e, 24h is converted into an asymmetrical signal, which is to say the signal referred to ground, and fed out over line 24f to the first, single-wire line 27a.

FIG. 5 is a detailed representation of conversion switch unit 29a shown in FIG. 4. Line 24f is connected to a first and a second capacitor 28l, 28m, which are in each case connected to a first or, as the case may be, second resistor 28f, 28d. The first resistor 28f is connected directly to line 24e (and hence to the first send output XP of ASICS 22a). In contrast to this, the second resistor is connected to inverter 28g whose input is connected to line 24e (and hence to the second send output XP of ASICS 22a).

Capacitors 28l, 28m each have, for example, a capacitance of 50 nF to 200 nF, in particular a capacitance C1 or, as the case may be, C2 of 100 nF, and resistors 28d, 28f have a resistance between 100Ω and 200Ω, in particular a resistance R1 or, as the case may be, R2 of 150Ω.

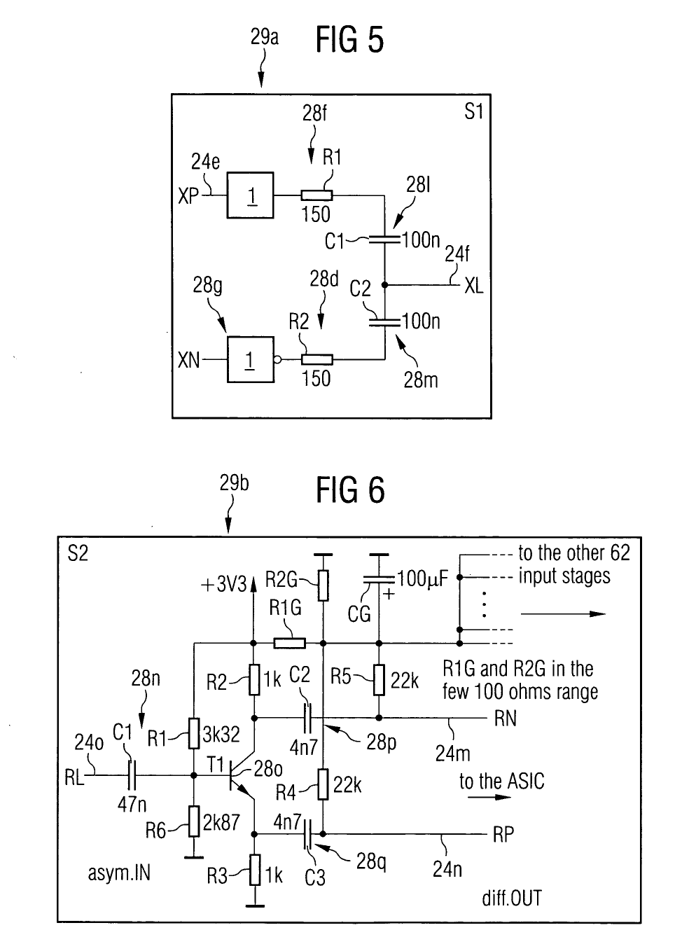

FIG. 6 is a detailed representation of conversion switch unit 29b shown in FIG. 4. Line 24o is connected, with interfacing provided by a capacitor 28n, to the base of a transistor 28o. The collector of transistor is connected, with interfacing provided by a capacitor 28p, to line 24m (and hence to the first receive input RN of ASICS 22a). The emitter of transistor 28o is analogously connected, with interfacing provided by a capacitor 28q, to line 24n (and hence to the second receive input RP of ASICS 22a).

Capacitor 28n has, for example, a capacitance of 1 nF to 200 nF, in particular a capacitance C1 of 47 nF, and capacitors 28p or, as the case may be, 28q have in each case a capacitance of 1 nF to 100 nF, in particular a capacitance C2 or, as the case may be, C3 of 4.7 nF.

At the dimensioning indicated of the conversion switch unit, the maximum permissible input signal voltage level Uₑ of conversion switch unit 29b (RL->ground) is 29b±0.75V. The differential output signal voltage level Uₐ (RN->RP) is then ±1.4V.

Again referred to FIG. 4, several other modules, for example 63 further modules, are connected to ASIC 22a or, as the case may be, module 22—alongside module 23—in a manner analogous to that described above via other line pairs corresponding to lines 27a, 27b (see also FIG. 6).

1. An electronic module comprising:
a transmitter device having at least two outputs via which a differential or symmetrical signal is sent from the transmitter device; and
a converter for converting the differential or symmetrical signal into an asymmetrical signal.

2. An electronic module according to claim 1, further comprising an interface device connected to the converter and connectable to a single-wire line via which the asymmetrical signal can be fed out.

3. An electronic module according to claim 2, further comprising a device whose impedance is selected such that the impedance of the electronic module is matched to that of the line.

4. An electronic module according to claim 1, wherein the transmitter device forms part of a PCM framer device.

5. An electronic module according to claim 1, wherein the asymmetrical signal is fed out via a module output which is connected via a first line to the first transmitter device-output and via a second line to the second transmitter device-output.

6. An electronic module according to claim 5, wherein the second line is connected, with interfacing provided by a resistor element, to the module output.

7. An electronic module according to claim 1, wherein the electronic module is located with other modules in a module racking facility.

8. An electronic module according to claim 7, wherein a line is formed at least partially by a module-rack backplane line.

9. An electronic module according to claim 7, wherein the modules form part of a terminating telephone switching center.

10. An electronic module according to claim 1, wherein the differential signal is a differential PCM signal or the symmetrical signal is a symmetrical PCM signal.

11. An electronic module comprising:
a receiver device having at least two inputs via which a differential or symmetrical signal is routed to the receiver device; and
an adapter enabling the receiver device designed for receiving symmetrical signals to receive asymmetrical signals.

12. An electronic module according to claim 11, wherein the first receiver device input is connected to a module input and the second receiver device input is grounded.

13. An electronic module according to claim 12, wherein the grounding is provided with interfacing provided by a capacitive component.

14. An electronic module according to claim 12, wherein the first receiver device input is connected to the module input with interfacing provided by a capacitive component.

15. An electronic module according to claim 11 further comprising:
a transmitter device having at least two outputs via which a differential or symmetrical signal is sent from the transmitter device; and
a converter for converting the differential or the symmetrical signal into an asymmetrical signal.

16. A data communication system comprising:
a first electronic module comprising:
a transmitter device having at least two outputs via which a differential or symmetrical signal is sent from the transmitter device; and
a converter for converting the differential or symmetrical signal into an asymmetrical signal; and
a second electronic module comprising:
a receiver device having at least two inputs via which a differential or symmetrical signal is routed to the receiver device; and
an adapter enabling the receiver device designed for receiving the symmetrical signals to receive the asymmetrical signals,
wherein the asymmetrical signal is transmitted over a single-wire line from the first electronic module to the second electronic module.

17. A data communication system according to claim 16, comprising a plurality of the first electronic modules connected by additional single-wire lines to the second electronic module.

18. An electronic module according to claim 2, wherein the transmitter device forms part of a PCM framer device.

19. An electronic module according to claim 2, wherein the asymmetrical signal is fed out via a module output is connected via a first line to the first transmitter device-output and via a second line to the second transmitter device-output.

20. An electronic module according to claim 13, wherein the first receiver device input is connected to the module input with interfacing provided by a capacitive component.
